(19) United States
(12) Patent Application Publication
(10) Pub. No.: US 2012/0312248 A1
(43) Pub. Date: Dec. 13, 2012

(54) PEST DETERRENT APPARATUS

(76) Inventor: Robert Alves, Marblehead, MA (US)

(21) Appl. No.: 13/417,166

(22) Filed: Mar. 9, 2012

Related U.S. Application Data
(60) Provisional application No. 61/451,109, filed on Mar. 9, 2011.

(51) Int. Cl. A01M 29/06

(52) U.S. Cl. 119/712

(57) ABSTRACT

A pest deterrent apparatus which includes a base module which resembles a body portion of a predator, a movable head module which resembles a head portion of the predator, the head module movably coupled to the base module through a first spring, and a tail module which resembles a tail portion of the predator, the tail module movably coupled to the base module through a second spring wherein the first and second spring are configured to allow the head module and the tail module to move in a random pattern.

### CROSS-REFERENCE TO RELATED APPLICATIONS

This application claims the benefit of U.S. Provisional Patent Application No. 61/451,109, filed on Mar. 9, 2011, the disclosure of which is incorporated herein in its entirety by reference.

### BACKGROUND OF THE INVENTION

1. Field of the Invention

The present general inventive concept relates to a deterrent apparatus, and more particularly to a pest deterrent apparatus used to prevent birds and/or other pests from defecating on a particular location.

2. Description

Many people desire to deter pests, such as birds, mice, and other animals away from a particular location, such as boats, decks, parking lots, and pools, in order to protect these locations from damage caused by these pests. If left undeterred, people are then forced to spend a considerable amount of time and money to clean up the waste residue from these pests. In addition to being costly, thousands of gallons of fresh-water are wasted each year when property owners clean up the waste and residue created by these pests. Also, many of the cleaners used to perform the clean-up contain toxic chemicals which are unfortunately deposited into waterways.

Currently, there exists various types of pest deterrent devices which are designed to scare away pests, thereby preventing the pests from damaging one's property. However, over a short period of time the pests learn that these devices are safe due to their predictable behavior and eventually return to the area and cause damage. In addition, currently available pest deterrent devices are often difficult to install, remain stationary, and if securely fastened, are difficult to remove from a user's property, such as from the roof-tops, the bow, and the bemini-covers of boats.

Moreover, currently available pest deterrent devices only deter birds and other pests from avoiding a small perimeter around the deterrent device and therefore fail to prevent the pests from defecating on and damaging areas outside of this radius. For example, conventionally known pest deterrent devices include an apparatus which rotates a rod around a limited horizontal plane. However, although some birds may be initially deterred from landing within the radius in which the rod rotates, all of the birds and pests will eventually learn that it is safe to land or sit outside of this specific area.

Therefore, over a short period of time, all of the birds and animals will resume landing on and feeding upon the owners property, while causing damage the user's property, thereby rendering the conventional pest deterrent devices ineffective.

Thus, what is needed is a deterrent device that resembles a predator and which moves in a random, unpredictable manner so as to continuously deter pests from a desired location.

### SUMMARY OF THE INVENTION

The present general inventive concept provides a pest deterrent device which includes a realistic head module, a realistic base module, and a realistic tail module which resemble a particular predator.

The present general inventive concept also provides that the head module and the tail module are moveably coupled to the base module through springs. The head module and the tail module may move independent of each other in a random pattern due to wind or a movement of the base module. For instance, in an exemplary embodiment, the head module and the tail module may move in a bobble-type motion.

The present general inventive concept also provides that the base module may open to reveal a storage compartment suitable for the head module, the tail module, and an stability module. The stability module may include any desired weighted object, such as a water bottle, brick, or sand. However, the present general inventive concept is not limited thereto.

The present general inventive concept also provides that the base module may be formed from a bean-bag having a rubberized bottom surface. The exterior surface of the bean-bag may be

covered with a waterproof fabric material. The interior of the bean-bag may be filled with water, sand, or other weighted object.

An exemplary embodiment of the present general inventive concept provides a pest deterrent apparatus which includes a base module which resembles a body portion of a predator, a movable head module which resembles a head portion of the predator, the head module movably coupled to the base module through a first spring, and a tail module which resembles a tail portion of the predator, the tail module movably coupled to the base module through a second spring, wherein the first and second spring are configured to allow the head module and the tail module to move in a random pattern.

The head module may be coupled to a first end of the first spring and the base module may be coupled to an opposite end of the first spring.

The tail module may be coupled to a first end of the second spring and the base module may be coupled to an opposite end of the second spring.

The base module may include a top base, a bottom base, and a hinge member which movably couples the top base to the bottom base.

The top base and the bottom base may form a storage cavity therebetween.

The head module, the tail module, and a weighted object may be stored within the storage cavity, when not in use.

The apparatus may include a pair of eye members which replicate eyes of the predator coupled to the head module.

The pair of eye members may be disposed on the head module to face in an upward direction.

The base module may be formed from a contourable bean-bag. The base module may be formed in a conical or rectangular shape.

The base module may be filled with a filler material to provide a weight to the base module.

The base module may include a first tension adjust member movable between a plurality of positions to adjust a tension of the first spring.

The plurality of positions may include a first position corresponding to a minimized tension on the first spring and a second position corresponding to a maximized tension on the first spring, the head module movable with a lesser force when at the first position than at the second position.

The base module may include a second tension adjust member movable between a plurality of positions to adjust a tension of the second spring.

The plurality of positions may include a first position corresponding to a minimized tension on the second spring and a second position corresponding to a maximized tension on the second spring, the tail module movable with a lesser force when at the first position than at the second position.

Alternative exemplary embodiments of the present general inventive concept may also provide a pest deterrent apparatus which includes a collapsible base module formed in a conical shape having a top end and a bottom end, a movable head module coupled to the top end of the base module, a movable tail module coupled to the bottom end of the base module, and wherein the movable head module is coupled to the base module via a first movable connector and the tail module is coupled to the base via a second movable connector.

At least one of the movable head module and the tail module may move via a pendulum device. At least one of the movable head and the tail module may move via a motor.

The first and second connector may allow the head module and tail module, respectively, move freely in response to a force applied thereto.

The first and second connector may each include a tension adjust member to control an amount of force required to move the head module and tail module.

Additional aspects of the present general inventive concept will be set forth in part in the description which follows and, in part, will be obvious from the description, or may be learned by practice of the general inventive concept.

### BRIEF DESCRIPTION OF THE DRAWINGS

These and/or other aspects of the present general inventive concept will become apparent and more readily appreciated from the following description of the embodiments, taken in conjunction with the accompanying drawings of which:

FIG. 1 is a front perspective view of an exemplary embodiment of the pest deterrent apparatus according to the present general inventive concept. FIG. 1 illustrates the pest deterrent apparatus looking in an upward direction;

FIG. 1A is a front perspective schematic view of the exemplary embodiment of FIG. 1;

FIG. 2 is a side perspective view of an exemplary embodiment of the pest deterrent apparatus of FIG. 1 in a closed state;

FIG. 3 is a front perspective view of the pest deterrent apparatus of FIG. 1 in an open state;

FIG. 3A is a front perspective schematic view of the exemplary embodiment of FIG. 3;

FIG. 4 is a bottom perspective view of the exemplary embodiment of the pest deterrent apparatus of FIG. 1;

FIG. 5 is a side perspective view of another exemplary embodiment of the pest deterrent apparatus according to the present general inventive concept;

FIG. 6 is a top perspective view of the exemplary embodiment illustrated in FIG. 5;

FIG. 7 is a schematic cross-sectional view illustrating a spring tension adjust member and a spring which connects the head module to the base module according to an exemplary embodiment of the present general inventive concept; and

FIG. 8 is a schematic cross-sectional view illustrating a light source disposed behind the eyes of the head module according to another exemplary embodiment of the present general inventive concept.

### DETAILED DESCRIPTION

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

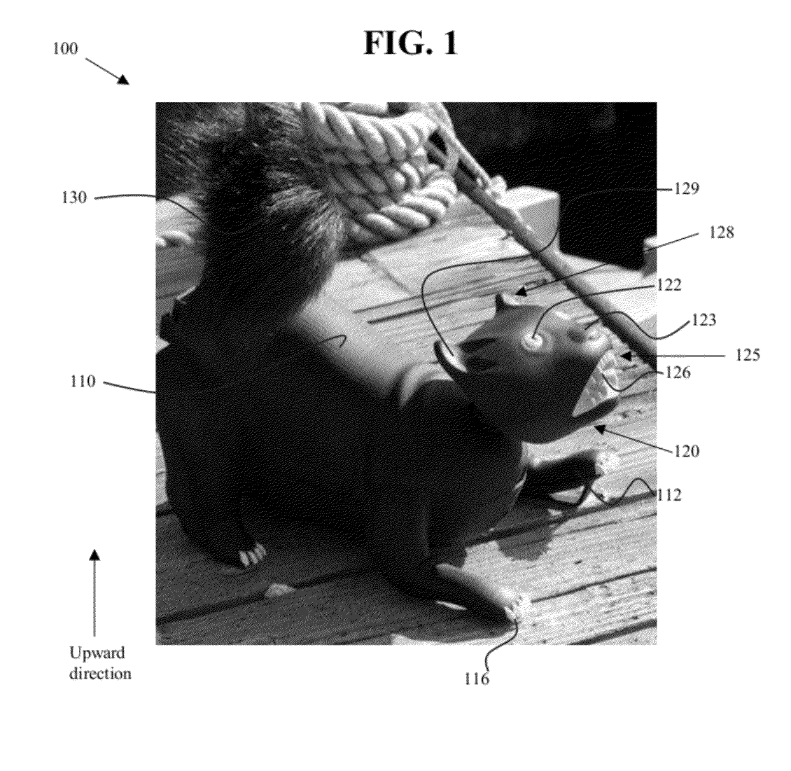

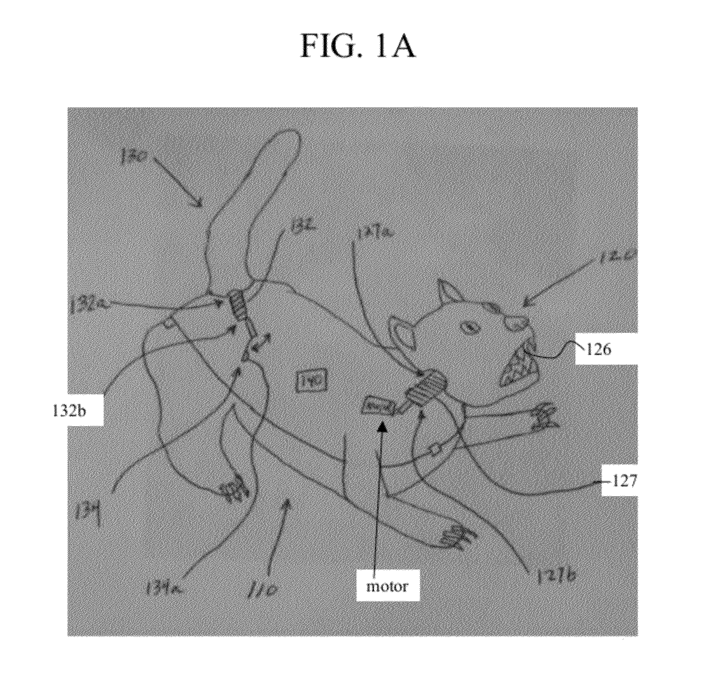

FIG. 1 illustrates a front perspective view of an exemplary embodiment of the pest deterrent apparatus 100 according to the present general inventive concept. FIG. 1A is a front perspective schematic view of the exemplary embodiment of FIG. 1. The pest deterrent apparatus 100 includes a base 110 (i.e., a base module), a head 120 (i.e., a head module), and a tail 130 (i.e., a tail module).

In an exemplary embodiment, the base module 100 may resemble a body portion of a predator of a particular pest for which a user desires to deter. That is, a size and/or shape of the base module 110 may be substantially similar to the size and/or shape of the body of a desired predator. The base module 110 may be formed to resemble to the body of the predator, which would prey on a particular pest the user desires to deter. For example, in exemplary embodiments, the predator may be a cat, a fox, a hawk, a snake, etc. However, the present general inventive concept is not limited thereto.

In the current exemplary embodiment, the predator may be a cat if the user desires to deter mice or birds, which are natural prey of cats. The base module 110 may be formed to resemble the cat posed in various positions, such as a prone position getting ready to attack it's prey, as illustrated in FIGS. 1 and 1A. However, the present general inventive concept is not limited thereto.

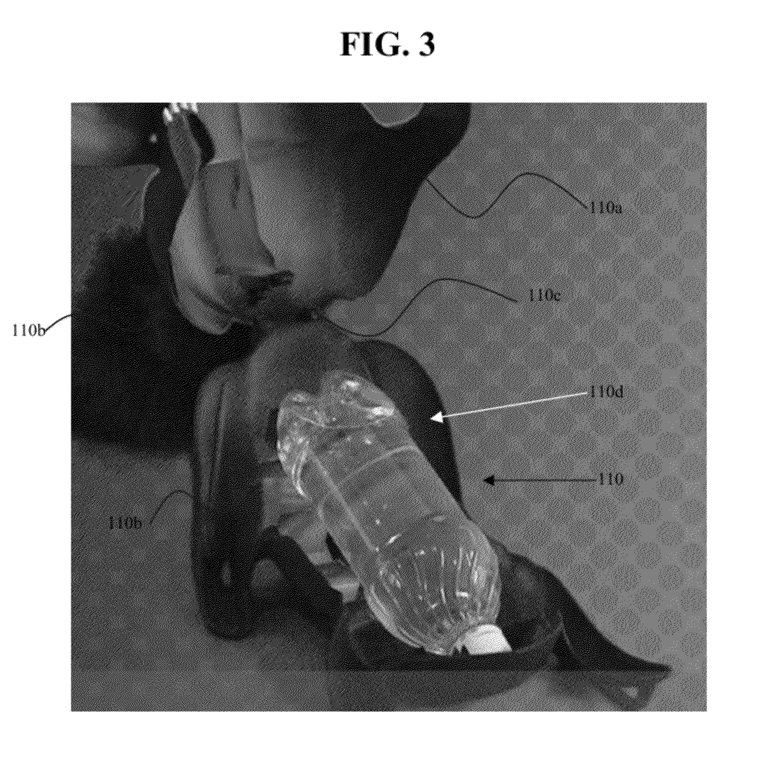

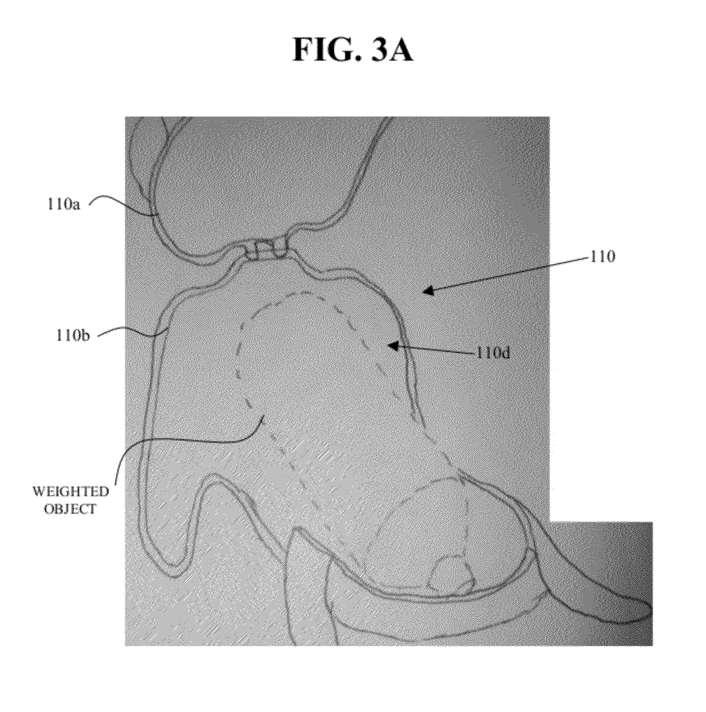

The base module 110 may include a plurality of features attached thereto including feet 112 and a storage compartment 110d (See FIG. 3). The feet 112 may further include realistic nails 116 which make the pest deterrent device 100 appear to be a more life-like to help deter pests, such as birds and mice.

In the current exemplary embodiment, the head module 120 may resemble a head portion of a cat. That is, a size and/or shape of the head module 120 may be substantially similar to the size and shape of the head of a desired predator, such as a cat. The head module 120 may be formed to resemble the head of the predator, which would prey on a particular pest, such as birds and mice, the user desires to deter. In exemplary embodiments, the head module 120 may be formed to resemble a cat facing in an upward direction, as illustrated in FIG. 1, to help deter birds from landing on a particular location.

The head module 120 may include a plurality of features including a pair of eyes 122, a nose 123, a pair of ears 124, and a mouth 125 with a plurality of teeth 126, so as to resemble the predator's face. The pair of eyes 122 may include a reflective material to reflect incoming light, thereby resembling realistic eyes. In an exemplary embodiment, the pest deterrent device 100 may include a plurality of LEDs 155 disposed within the head module 120 and/or within the pair of eyes 122 to be illuminated at night. In alternative exemplary embodiments, the pair of eyes 122 may further include solar panels to store energy from the sun. This energy may then be used to create a movement of the head module 120 by operating a motor (see FIG. 1a) disposed within the base module 110. The mouth 129 may be opened, exposing the plurality of teeth 126 therein, so as to further frighten pests.

In an exemplary embodiment, the head module 120 is detachably coupled to the base module 110 through a spring 127 (i.e. a first spring). The head module 120 may be configured to move in a bobble-type movement in response to a force applied thereto. The head module 120 is attached to a first end 127a of the first spring 127 and the base module 110 is attached to the opposite end 122b of the first spring 127, so as to allow the head module 120 to move in the bobble-type movement, mimicking a movement of a real predator. This configuration allows the head module 120 to move freely and/or randomly when a force, such as wind is applied to the head module 120.

In exemplary embodiments, an amount of movement of the head module 120 may be controlled by adjusting a length and/or wire thickness of the first spring 127.

In addition, a movement of the surface on which the pest deterrent device 100 is placed may translate into a movement of the head module 120. For instance, when the pest deterrent device 100 is placed on a boat, a movement of the ocean and/or wind would cause the head module 120 to bobble. In an embodiment, the pair of ears 124 may be cup-shaped so as to increase a surface area for which wind may be collected to create a force that is applied to the head module 120.

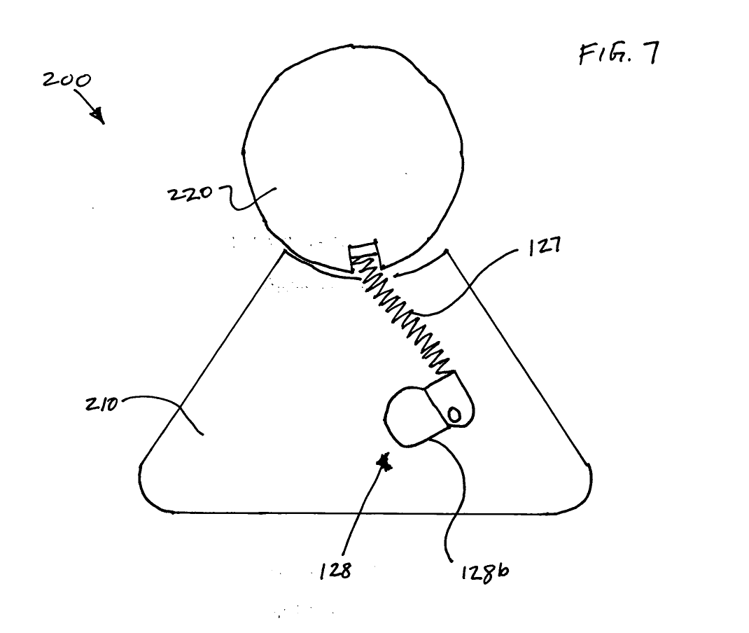

In alternative exemplary embodiments, the head module 120 may further include a spring tension adjust member 128 (see FIG. 7) which is movable between a plurality of positions. In particular, the tension adjust member may be moved to a first position 128a to decrease a tension of the first spring 127 and to a second position 128b to increase a tension of the first spring 127. The spring tension would control the amount the head module 120 moved in response to a force, such as wind. The spring tension adjust member 128 may include a knob accessible from an outer surface of the base module 110, so that a user may adjust a tension and therefore an amount of movement of the head module 120.

In exemplary embodiments, the tail module 130 resembles a tail portion of a desired predator. That is, a size and/or shape of the tail module 130 may be substantially similar to the size and/or shape of a tail of a desired predator. For example, a predator may include a cat, a fox, a hawk, a snake, etc. However, the present general inventive concept is not limited thereto.

In the current exemplary embodiment, the tail module 130 may be formed to resemble the tail of a cat. However, the present general inventive concept is not limited thereto. That is, in alternative exemplary embodiments, the tail module 130 may also resemble the tail of any other predators which would prey on a particular pest the user desires to deter. The tail module 130 may be covered by a fur material so as to resemble the tail of a cat. However, the tail module 130 may also be covered with a water-proof material, yet still resembling the tail of a cat.

In an exemplary embodiment, the tail module 130 is detachably coupled to the base module 110 through a spring 132 (i.e. a second spring). The tail module 130 may be configured to move in a bobble-type movement in response to a force applied thereto. The tail module 130 is attached to a first end 132a of the second spring 132 and the base module 110 is attached to the opposite end 132b of the second spring 132, so as to allow the tail module 130 to move in a bobble-type movement, mimicking a movement of a real predator. This configuration allows the tail module 130 to move freely and/or randomly when a force, such as wind is applied to the tail module 120.

In exemplary embodiments, the user may easily attach and remove the tail module 130 from the base module 110. The tail module 130 may be coated with a UV protective material to protect the tail module 130 from the sun.

In exemplary embodiments, the tail module 130 may include a spring mechanism or a pendulum mechanism 134 which may be located within the base module 110 and which is used to generate a force to move the tail and/or head module. That is, the pendulum mechanism 134 may include a mass 134a having a particular weight which would use gravity, wind, a movement of the sea, sun or water. In turn, the movement of the tail module 130 may also transfer potential kinetic energy to thereby move the head module 120. The mass 134a would swing (in the path illustrated in FIG. 1A) and thereby transfer this energy through a series of gears or mechanical linkages (not illustrated) to move the head module 120 and the tail module 130, which resembles life-life motions of a predator, such as a cat.

In alternative embodiments, the head module 120 may include a wind catching member 129 (see FIG. 1) to capture wind to the thereby help move or bobble the head module 120. That is, the head module 130 may also be moved by the force of wind pushing against the wind catching members 129 disposed on the head module 120.

In further embodiments, the wind catching members 120 may be formed to resemble the predator's ears. That is, a natural movement of the wind activates a movement of the tail module 130 and the head module 120. In addition, a movement of the entire pest deterrent apparatus 100 caused by a movement of the object on which the apparatus is placed, such as a boat, generates a bobble-type movement of the head module 120 and the tail module 130.

The movement of the head module 120 and the tail module 130 would mimic that of a real predator so as to deter birds and other pests away from a desired location. Also, alternative embodiments may include solar panels in the eyes to generate the necessary energy to turn a motor (see FIG. 1a) or a pendulum (see FIG. 1a) to induce a life-like action-orientated mannerism.

In yet further alternative embodiments, the pest deterrent apparatus 200 of the present invention may include a sound system, which produces the sound made by a desired predator. For instance, if the pest deterrent apparatus 100 resembles a cat, the sound system would produce a sound similar to that of a cat to assist in deterring pests. The sound system would further include a control module 140 (see FIG. 1a) which allows a user to play a variety of pre-recorded sounds. These sounds may include typical sounds produced by the particular predator and/or or sounds emitted at specific frequencies to assist in deterring a desired pest.

In yet further embodiments, the present general inventive concept may include a sound-capsule disposed within the base module to provide a sound. For instance, the sound module may be formed with a hardened outer shell and having beads, ball bearings, bells, or the like disposed therein to further assist in creating a sound to deter pests. A movement of the sound module would rattle the objects disposed therein to create a sound which would frighten pests.

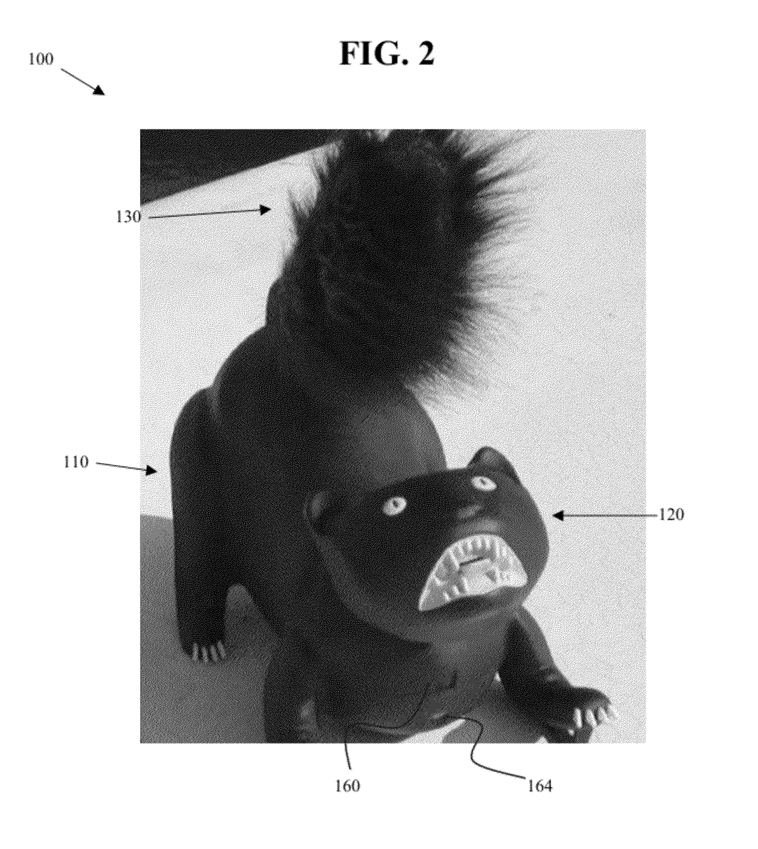

FIG. 2 is a side perspective view of an exemplary embodiment of the pest deterrent apparatus 100 of FIG. 1 in a closed state and FIG. 3 is a front perspective view of the pest deterrent apparatus of FIG. 1 in an open state. FIG. 3A is a front perspective schematic view of the exemplary embodiment of FIG. 3.

Referring to FIGS. 2 and 3, the base module 110 is formed from a top base 110a and a bottom base 110b, which are coupled to each other by a hinge 110c. In exemplary embodiments, the top base 110a and the bottom base 110b form a storage cavity 110d.

As illustrated in FIG. 2, the top base 110a and the bottom base 110b may be in a closed state, wherein the cavity 110d is hidden from view. However, when the pest deterrent device 100 is not in use, a user may store the head module 120, the tail module 130, and a weighted object within the storage cavity 110d by opening the top base 110a. As illustrated in FIG. 2, the top base 110a includes a latch 160 and the bottom base 110b includes a latch lock 164 which may be used to secure the top base 110a to the bottom base 110b.

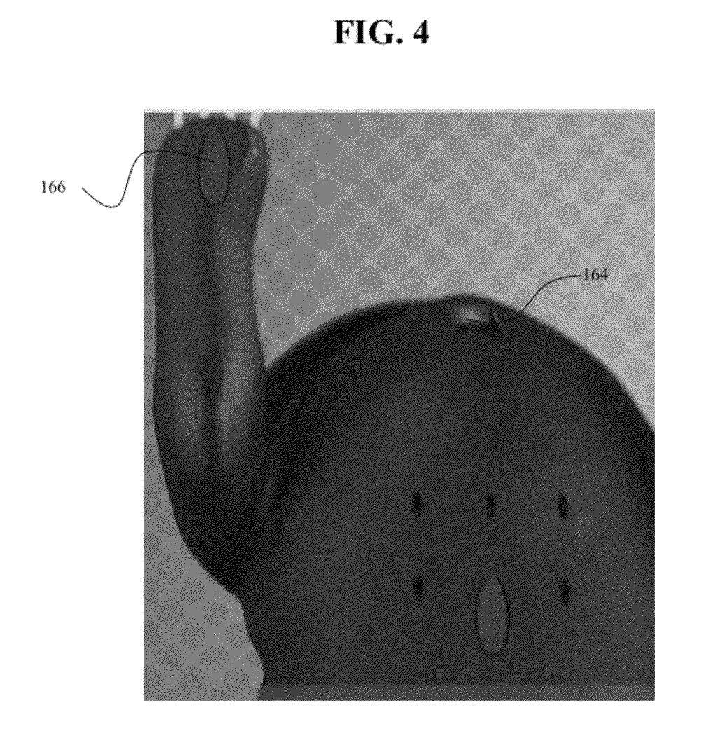

FIG. 4 is a bottom perspective view of the exemplary embodiment of the pest deterrent apparatus 100 of FIG. 1. In exemplary embodiments, the feet 112 may include traction pads 166 to help secure the pest deterrent device to a slippery surface. The traction pads 166 may be formed from rubber or various other materials that increase friction between the apparatus 100 and a surface.

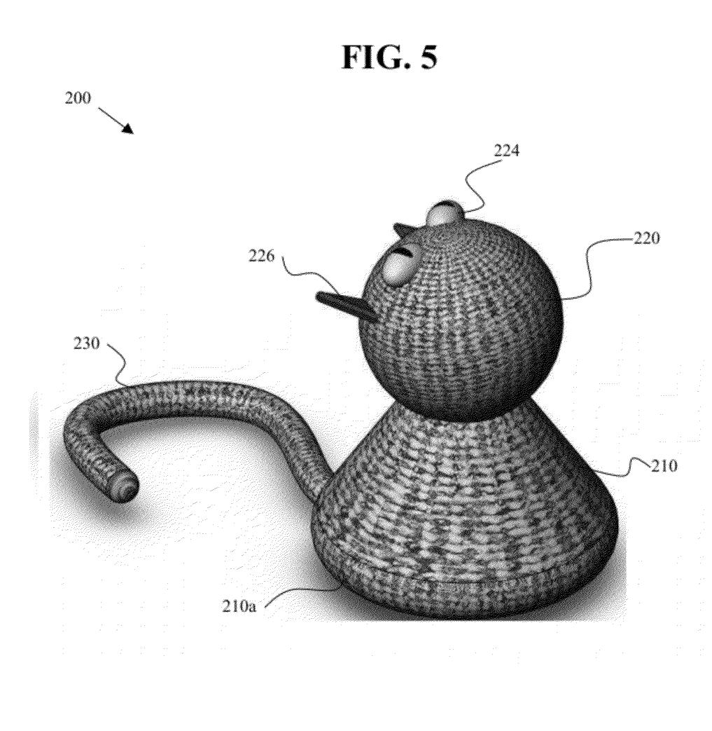

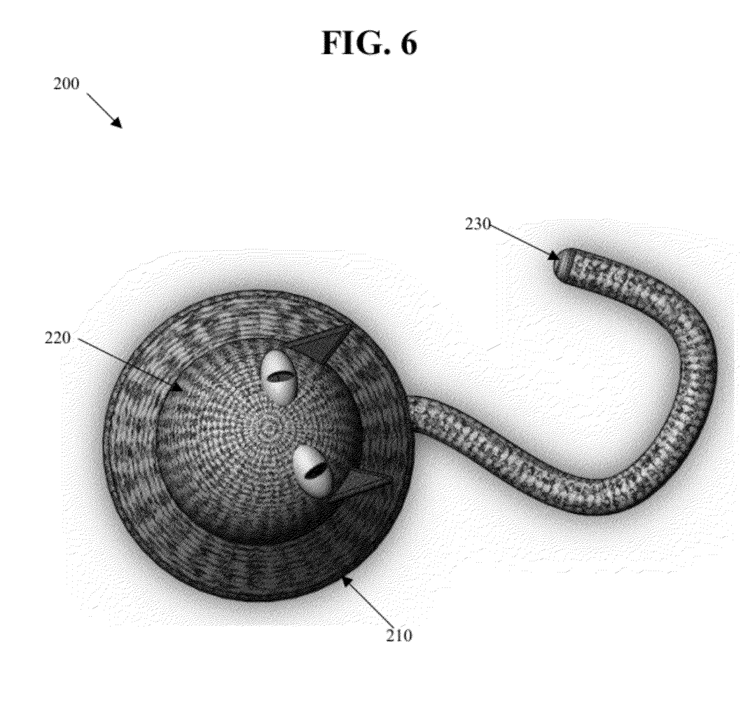

FIG. 5 is a side perspective view of another exemplary embodiment of the pest deterrent apparatus 200 according to the present general inventive concept and FIG. 6 is a top perspective view of the exemplary embodiment illustrated in FIG. 5.

Referring to FIG. 5, the base module 210 resembles a body portion or torso of a predator, such as a cat, by having a conical shape. In exemplary embodiments, the base my be formed from a bean-bag and may have a rubberized bottom surface 210. The bean bag may contour to take the shape of an irregular surface on which the base module 210 is placed. That is, the base module 210 contours to irregular surfaces found on boats, porches, buildings, rock gardens, yards and the like to help secure the base module. Moreover, the conical body shape allows for a wide base preventing the present general inventive from easily tipping over.

In an exemplary embodiment, the pest deterrent apparatus 200 includes a head 220, a body 210, and a tail module 230 which resembles the size and shape of a sitting cat (i.e., a predator) in order to deter birds, rabbits, rats, and other animals (i.e., pests) away from a particular location.

In exemplary embodiments, the body 210 may be formed in various sizes and shapes. That is, the base module 210 may be formed in a rectangular shape, a triangular conical shape, or various other shapes to resemble the predator disposed in various positions. The base module 210 is constructed as a weighted and contourable bean-bag which may be filled with a desired filler material. The filler material may include sand, rocks, air, helium, beans, water, etc. The bean-bag would be sealed so as to be air-tight to prevent the filler material from escaping and also to prevent moisture from entering into the bean-bag. The base module 210 may include a lid (e.g., top base similar to 110a) which may be opened to reveal a cavity disposed therein and closed to allow a user to access an inner cavity formed by the base module 210. For example, the lid may be hinged to a portion of the base module 210 so as to allow the lid to be opened for the user to fill the base module 210 with the filler material and also to be closed to prevent the filler material from escaping.

The base module 210 may be constructed from a weather resistant material so as to be able to withstand all types of weather conditions. For example, the base module 210 may be formed of a rubber, a thermoplastic, a fabric, or the like to be able to be used indoors and outdoors for long periods of time. The base module 210 is waterproof and resistant to ultraviolet (UV) exposure. The base module 210 may be flexible and also durable to withstand harsh conditions, for instance, those caused by saltwater, snow, wind, hail, and rain. In exemplary embodiments, the base module 210 may include a flotation module, which would provide buoyancy for the entire pest deterrent device in freshwater or in saltwater. In exemplary embodiments, the pest deterrent apparatus 200 may deter pests while floating in a pool, pond, or other body of water.

In alternative exemplary embodiments, the base module 210 and the tail module 230 may further include a spring tension adjust member 128 which may be adjusted to thereby control a tension of the first and second springs 127 and 132, respectively.

That is, the head module 220 may move in a bobble-type movement when a force such as wind, water or a force created by the movement of the structure on which the apparatus 200 rests, moves. The tension applied by the spring onto the head module 220 controls the amount of force required to move or bobble the head module 220. In addition, the present invention allows a user to adjust the spring-tension member 128 to control movement of head-module 220 by adjusting the tension of the spring. In an exemplary embodiment, the user may adjust the tension of either the first spring 127 or the second spring 132 by moving the spring tension adjust member 128 between a first tension position 128a and a second tension position 128b. That is, in exemplary embodiments, the pest deterrent apparatus includes a first spring tension adjust member corresponding to the head module 220 and a second spring tension adjust member corresponding to the tail module 230.

The current exemplary embodiment may further include a pair of eye members 224 which replicate eyes of the predator and which are coupled to the head module 220. The pair of eye members 224 are disposed on the head module 220 so as to face in an upward direction. The head module 220 may further include a pair of ears 226 which may be used to assist in the movement of the head module 220 by collecting wind.

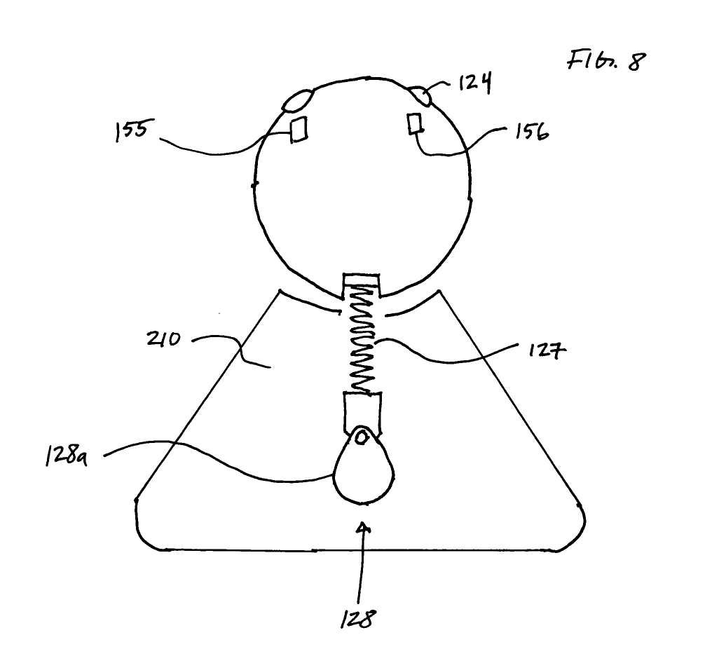

FIG. 7 is a schematic cross-sectional view illustrating a spring tension adjust member 128 and a first spring 127 which connects the head module 220 to the base module 210 according to an exemplary embodiment of the present general inventive concept. FIG. 8 is a schematic cross-sectional view illustrating a light source disposed behind the eyes of the head module according to another exemplary embodiment of the present general inventive concept.

Referring to FIG. 7, in exemplary embodiments, the pest deterrent apparatus 200 may include a spring tension adjust member 128, which may be moved from a first tension position 128a, wherein the tension of the spring 127 is at a minimized state, to a second tension position 128b, wherein the tension of the spring 127 is at a maximized state.

Referring to FIG. 8, in exemplary embodiments, the pest deterrent apparatus 200 may further include a light source 155 disposed within the eyes 224 of the head module 220.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents.

What is claimed is:

1. A pest deterrent apparatus comprising:
a base module which resembles a body portion of a predator;
a movable head module which resembles a head portion of the predator, the head module movably coupled to the base module through a first spring; and
a tail module which resembles a tail portion of the predator, the tail module movably coupled to the base module through a second spring,
wherein the first and second spring are configured to allow the head module and the tail module to move in a random pattern.

2. The pest deterrent apparatus of claim 1, wherein the head module is coupled to a first end of the first spring and the base module is coupled to an opposite end of the first spring.

3. The pest deterrent apparatus of claim 1, wherein the tail module is coupled to a first end of the second spring and the base module is coupled to an opposite end of the second spring.

4. The pest deterrent apparatus of claim 1, wherein the base module includes a top base, a bottom base, and a hinge member which movably couples the top base to the bottom base.

5. The pest deterrent apparatus of claim 4, wherein the top base and the bottom base form a storage cavity therebetween.

6. The pest deterrent apparatus of claim 5, wherein the head module, the tail module, and a weighted object is stored within the storage cavity, when not in use.

7. The pest deterrent apparatus of claim 1, further comprising a pair of eye members which replicate eyes of the predator coupled to the head module.

8. The pest deterrent apparatus of claim 7, wherein the pair of eye members are disposed on the head module to face in an upward direction.

9. The pest deterrent apparatus of claim 1, wherein the base module is formed from a contourable bean-bag.

10. The pest deterrent apparatus of claim 9, wherein the base module is formed in a conical or rectangular shape.

11. The pest deterrent apparatus of claim 4, wherein the base module is filled with a filler material to provide a weight to the base module.

12. The pest deterrent apparatus of claim 2, wherein the base module includes a first tension adjust member movable between a plurality of positions to adjust a tension of the first spring.

13. The pest deterrent apparatus of claim 12, wherein the plurality of positions include a first position corresponding to a minimized tension on the first spring and a second position corresponding to a maximized tension on the first spring, the head module movable with a lesser force when at the first position than at the second position.

14. The pest deterrent apparatus of claim 3, wherein the base module includes a second tension adjust member movable between a plurality of positions to adjust a tension of the second spring.

15. The pest deterrent apparatus of claim 14, wherein the plurality of positions include a first position corresponding to a minimized tension on the second spring and a second position corresponding to a maximized tension on the second spring, the tail module movable with a lesser force when at the first position than at the second position.

16. A pest deterrent apparatus comprising:
a collapsible base module formed in a conical shape having a top end and a bottom end;
a movable head module coupled to the top end of the base module;
a movable tail module coupled to the bottom end of the base module; and
wherein the movable head module is coupled to the base module via a first movable connector and the tail module is coupled to the base via a second movable connector.

17. The pest deterrent apparatus of claim 16, wherein at least one of the movable head module and the tail module moves via a pendulum device.

18. The pest deterrent apparatus of claim 16, wherein at least one of the movable head and the tail module moves via a motor.

19. The pest deterrent apparatus of claim 16, wherein the first and second connector allow the head module and tail module, respectively, move freely in response to a force applied thereto.

20. The pest deterrent apparatus of claim 19, wherein the first and second connector each include a tension adjust member to control an amount of force required to move the head module and tail module.
